(19) United States
(12) Patent Application Publication
(10) Pub. No.: US 2026/0192819 A1
(43) Pub. Date: Jul. 9, 2026

(54) Method and Apparatus for Planning a Lane Change of a Vehicle

(71) Applicant: Daimler Truck AG, Leinfelden-Echterdingen (DE)

(72) Inventor: Fridtjof STEIN, Ostfildern (DE)

(21) Appl. No.: 18/863,899

(22) PCT Filed: Apr. 20, 2023
(86) PCT No.: PCT/EP2023/060230

§ 371 Date: Nov. 7, 2024

(30) Foreign Application Priority Data
May 9, 2022 (DE) 10 2022 111 538.0

(51) Int. Cl. B60W 60/00

(52) U.S. Cl. CPC B60W 60/001; B60W 2420/403; B60W 2520/125

(57) ABSTRACT

A method for planning a lane change of a vehicle from an acceleration section, on which the vehicle is accelerated, to a neighboring lane, where a topology of the acceleration section is taken into account to determine an achievable acceleration of the vehicle over the acceleration section. A detection range of at least one rearward-facing environment detection sensor of the vehicle is adapted depending on the topology of the acceleration section and/or of a preceding section of the neighboring lane.

### BACKGROUND AND SUMMARY OF THE INVENTION

The invention relates to a method for planning a lane change of a vehicle and to an apparatus for planning a lane change of a vehicle.

A method for optimizing maneuver planning for autonomously driving vehicles is known from the prior art, as described in DE 10 2017 200 580 A1. The method comprises a planning level which is divided into at least three different abstraction levels for all planning layers of the planning level. A combination of continuous planning and semantic information is performed by grouping several identified maneuver options and evaluating the success of each maneuver option, taking into account uncertainties in the behavior of other road users, in order to select the best strategy for performance.

Systems and methods for navigating with safe distances are described in EP 3 854 646 A2. At least one processing device is programmed to receive an image which represents surroundings of the ego vehicle, to determine a planned navigation action for the ego vehicle, to analyze the image in order to identify a target vehicle with a direction of travel in the direction of the ego vehicle, and to determine a distance between the ego vehicle and the target vehicle which would result if the planned navigation action were carried out. The at least one processing device also determines a braking distance for the ego vehicle based on a braking rate, a maximum acceleration capability and a current speed of the ego vehicle, a braking distance for the target vehicle based on a braking rate, a maximum acceleration capability and a current speed of the target vehicle, and implements the planned navigation action if the determined distance is greater than a total of the braking distances for the ego vehicle and the target vehicle.

A driver assistance system for supporting a driver when driving a vehicle is known from DE 10 2016 205 152 A1. The driver assistance system comprises at least one sensor, which is set up to at least partially detect a driving situation of a vehicle, and at least one first data interface for reading in traffic data about a road lying ahead. Furthermore, the driver assistance system comprises at least one second data interface for reading in lane data, in particular topography and/or lane layout of a lane section lying ahead and/or a preceding lane section. A prediction module of the driver assistance system is set up to dynamically simulate at least one future driving scenario based on the current driving situation, the traffic data and the lane data and then to dynamically simulate and output possible trajectories of the vehicle based on the at least one future driving scenario. An optimization module of the driver assistance system is set up to select and output one of the possible trajectories using at least one predetermined boundary condition which characterizes a driving style attribute of the driver assistance system. A control module is connected to the steering system, the braking system and/or the drive system of the vehicle in order to guide the vehicle based on the selected trajectory.

The invention is based on the object of specifying a method, improved with respect to the prior art, and an apparatus, improved with respect to the prior art, for planning a lane change of a vehicle.

In a method for planning a lane change of a vehicle from an acceleration section, on which the vehicle is accelerated, to a neighboring lane, in particular it is provided that an achievable acceleration of the vehicle over the acceleration section is determined, wherein a topology of the acceleration section is taken into account for this purpose. In particular, the method is carried out in the vehicle, in particular by the vehicle and/or by an apparatus arranged in the vehicle. In particular, the vehicle is a commercial vehicle, in particular a heavy goods vehicle. The vehicle is in particular formed and set up to carry out an automated, in particular partially automated, highly automated or autonomous driving operation.

According to the invention, a detection range of at least one rearward-facing environment detection sensor of the vehicle is adapted depending on the topology of the acceleration section and/or depending on a topology of a preceding section of the neighboring lane. In particular, the at least one rearward-facing environment detection sensor is formed, arranged on the vehicle and orientated in such a way that the neighboring lane, in particular a region, lying behind the at least one environment detection sensor or at least behind the vehicle, of the neighboring lane, in particular of the preceding section of the neighboring lane, is detected by means of this environment detection sensor, in particular by means of its detection range. This corresponds to the so-called look over the shoulder of a human vehicle driver when changing lane. The detection range of the environment detection sensor is also referred to as a frustum.

Advantageously, with the solution according to the invention, the topology is taken into account in planning a lane change and in particular also in carrying out the lane change. The solution according to the invention is particularly advantageous when the acceleration section is a descending or ascending section, since then the achievable acceleration of the vehicle changes in comparison to a level, i.e., horizontal, acceleration section. On the level acceleration section, the achievable acceleration of the vehicle is achieved merely by a drive arrangement of the vehicle, i.e., by one or more drive units for driving the vehicle. On a descending section, the achievable acceleration of the vehicle is greater than on the level acceleration section, since here the downhill-slope force accelerates the vehicle, whereby the vehicle is additionally accelerated in comparison to the level acceleration section. On an ascending section, the achievable acceleration of the vehicle is lower than on the level acceleration section, since here the downhill-slope force decelerates the vehicle, whereby the vehicle is accelerated less in comparison to the level acceleration section. Additionally, driving the descending section or ascending section and the orientation of the vehicle resulting therefrom relative to horizontal also acts on the orientation of the at least one environment detection sensor and thus the orientation of the detection range thereof. In particular if an inclination of the neighboring lane deviates from the inclination of the acceleration section, i.e., when the neighboring lane for example, does not have a descent or ascent, but is orientated horizontal, this has an effect on the area or section of the neighboring lane that can actually be detected by means of the environment detection sensor. Therefore, adapting the detection range depending on the topology is particularly advantageous.

The solution according to the invention thus enables improved lane change planning, in particular during an autonomous driving operation, by taking into account the topology.

In a possible embodiment, a lane change speed is determined which the vehicle has or will have at the determined achievable acceleration at the time of the lane change when the vehicle is operated with the determined achievable acceleration, and the detection range of the at least one rearward-facing environment detection sensor of the vehicle is adapted depending on the determined lane change speed. Therefore, a required detection range is ensured for each lane change speed, because the detection range has to be greater, in particular longer, at lower lane change speeds than at higher lane change speeds, since at lower lane change speeds, a relative speed in relation to road users on the neighboring lane is greater than at higher lane change speeds, or this can be assumed at least.

In a possible embodiment, a length of the detection range required for the determined lane change speed is determined and the detection range is adapted in such a way that the neighboring lane is detected over the entire determined required length. Therefore, a sufficient detection range corresponding to the respective lane change speed is ensured. A starting point of the required length is in particular an origin of the detection range, i.e., that point or area at which the detection range begins on the environment detection sensor.

In a possible embodiment, a camera is used as a rearward-facing environment detection sensor, for example a mono camera or stereo camera. Alternatively, other environment detection sensors can also be used, for example radar, lidar or ultrasound. If several environment detection sensors are used, these can be formed identically or differently, i.e., a combination of identical or different environment detection sensors can be used. By using a camera as an environment detection sensor, the environment detection by means of the environment detection sensor corresponds to that of the human eye when looking over the shoulder.

In a possible embodiment, the detection range is adapted by orientating the at least one environment detection sensor, for example by means of a gimbal actuator, also referred to as a gimbal or gimbal trim actuator. The gimbal actuator can advantageously change the orientation of the at least one environment detection sensor in the horizontal and/or vertical direction, whereby adaptation of the detection range is enabled.

In a possible embodiment, in particular when a camera is used as a rearward-facing environment detection sensor, the detection range is adapted by adapting a focal length and/or an angle of view and/or a lens aperture angle of the at least one environment detection sensor. Therefore, it is not required to change the orientation of the entire environment detection sensor. Alternatively, it can be provided, for example, that the focal length and/or the angle of view and/or the lens aperture angle of the at least one environment detection sensor is/are specified in such a way that for each traffic scenario, in particular topology scenario, which the vehicle can encounter, a respectively required detection range is possible, determined in particular by means of this method. The environment detection sensor is then formed and set up accordingly. This is in particular achieved by designing the detection range, i.e., the frustum, of the at least one rearward-facing environment detection sensor corresponding to a maximum uphill lane slope to be expected and/or corresponding to a maximum downhill lane slope to be expected. In the case of an environment detection sensor formed as a camera, this is achievable, for example, with a correspondingly large lens aperture angle. Therefore, for example, a software-controlled, in particular electronic and/or digital, adaptation of the detection range is enabled, by, for example, evaluating only one respective image area of a detected image. Therefore, mechanical movement for adapting the detection range is not required.

An apparatus according to the invention for planning a lane change of the vehicle is formed and set up to carry out the method. The apparatus is in particular arranged in the vehicle or the vehicle is this apparatus, i.e., the method is carried out by the vehicle and/or by the apparatus arranged in the vehicle. The advantages resulting therefrom are already described above for the method carried out by means of the apparatus.

In a possible embodiment, the apparatus has a determining unit. In particular, one or more or all of the above-described determinations of the method are carried out in the determining unit. In particular, the entire method is carried out in the determining unit, except for adapting the detection range. The determining unit is formed and set up for this. The determining unit is in particular formed and set up to determine at least the acceleration achievable over the acceleration section and/or the required adaptation of the detection range of the at least one environment detection sensor. Alternatively or additionally, the determining unit is formed and set up to determine the lane change speed, which the vehicle has at the determined achievable acceleration at the time of the lane change, and/or to determine the required length of the detection range. The advantages resulting therefrom are already described above for the method to be carried out by means of the apparatus.

In a possible embodiment, the apparatus comprises the at least one environment detection sensor and/or the gimbal actuator and/or a position determining unit for determining a current position of the vehicle and/or a digital map and/or an inertial sensor system and/or a speed detection sensor system for detecting a speed of the vehicle. The advantages resulting therefrom are already described above for the method to be carried out by means of the apparatus. The position determining unit is in particular provided to determine the current position of the vehicle by means of a global navigation satellite system and formed and set up accordingly. The position determination and the digital map in particular enable reading out of topology information for the current position of the vehicle and for the area around this current position from the digital map. The digital map therefore advantageously has such information on the topology which is required for the method. The inertial sensor system enables the determination of the ascent or the descent of the acceleration section, when this is being driven on by the vehicle. The speed detection sensor system enables detection of the current speed and thus, by means of the determined achievable acceleration, the determination of the lane change speed, which the vehicle has or will have with the determined achievable acceleration at the time of the lane change.

Exemplary embodiments of the invention are explained in more detail in the following using the drawings.

### BRIEF DESCRIPTION OF THE DRAWINGS

FIG. 1 schematically shows an example of a lane change of a vehicle from an acceleration section, on which the vehicle is accelerated, to a neighboring lane;

FIG. 2 schematically shows an example of a lane change with a level acceleration section;

FIG. 3 schematically shows an example of a lane change with an acceleration section formed as a descending section;

FIG. 4 schematically shows a length of a detection range of a rearward-facing environment detection sensor with a level acceleration section;

FIG. 5 schematically shows a length of a detection range of a rearward-facing environment detection sensor with an acceleration section formed as a descending section;

FIG. 6 schematically shows another example of a lane change with an acceleration section formed as a descending section;

FIG. 7 schematically shows an example of a lane change with an acceleration section formed as an ascending section;

FIG. 8 schematically shows a vehicle; and

FIG. 9 schematically shows an apparatus for carrying out a method for planning a lane change.

### DETAILED DESCRIPTION OF THE DRAWINGS

Parts corresponding to one another are provided with the same reference numerals in all the figures.

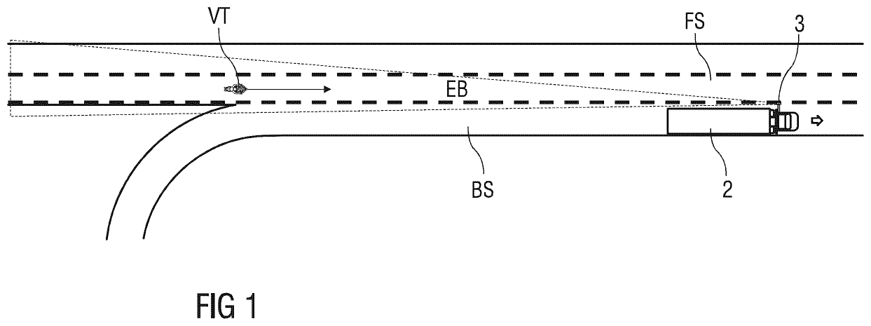

In the following, a method and an apparatus 1, formed and set up to carry out the method, for planning a lane change of a vehicle 2 from an acceleration section BS, on which the vehicle 2 is accelerated, to a neighboring lane FS is described using FIGS. 1 to 9.

In the represented example, the vehicle 2 is a commercial vehicle, formed as a heavy goods vehicle, more precisely a tractor unit, in particular a semi-trailer tractor.

The vehicle 2 is in particular formed and set up to carry out an automated driving operation, in the represented example for carrying out an autonomous driving operation.

Perception and surveying of the surroundings of the vehicle 2 is necessary for autonomous driving. For this, the vehicle 2 has environment detection sensors 3, 4 which are each formed as a lidar sensor, camera, radar sensor or ultrasound sensor.

In particular, in the autonomous driving operation, a lane change, in particular for merging from the acceleration section BS into flowing traffic in the neighboring lane FS represents a great challenge. An example of this is represented in FIG. 1.

In vehicles 2 driven by a human vehicle driver, the vehicle driver looks over their shoulder in order to check whether the neighboring lane FS is free. The human vehicle driver adjusts how far they look over their shoulder depending on the given circumstances.

The driver's look over their shoulder does not have to extend far when changing lanes in moving traffic. When merging into traffic on a motorway, starting at a low speed v, as represented in FIG. 1, the driver's viewing distance has to reach very far. The respective values for the viewing distance are dependent on a maximum achievable acceleration, which in the case of vehicles 2 formed as heavy goods vehicles also depends on the load, as well as on the maximum speed of other road users VT in the neighboring lane FS. The required very far-reaching viewing distance in particular results from a very low achievable acceleration of heavy goods vehicles. It takes a long time until a heavy goods vehicle has achieved an acceptable speed v and can merge into the moving traffic in the neighboring lane FS without representing an obstacle or hazard due to excessive relative speeds.

A topology of the acceleration section BS, i.e., whether the acceleration section BS is level or has an ascent or descent, has a particular influence on the achievable acceleration. Therefore, the required viewing distance is also dependent thereon. Additionally, the topology of the acceleration section BS and a topology of a preceding section, i.e., behind the vehicle 2, of the neighboring lane FS can compromise the viewing distance. The human vehicle driver reacts to this by adjusting their line of sight.

Thus, the experienced human vehicle driver subconsciously includes the topology-related acceleration possibilities and visibility possibilities in their lane change planning and when carrying out a lane change.

This is also made possible for the automated, in particular autonomous, driving operation of the vehicle 2, formed in particular as a heavy goods vehicle, with the solution described in the following.

In order to be able to carry out the lane change in the automated, in particular autonomous, driving operation, at least one of the environment detection sensors 3, 4 of the vehicle 2 is rearward-facing. It is, as shown in FIG. 1, in particular formed, arranged on the vehicle 2 and orientated in such a way that the neighboring lane FS, in particular a region, lying behind the rearward-facing environment detection sensor 3 or at least behind the vehicle 2, of the neighboring lane FS, in particular of the preceding section of the neighboring lane FS, is detected by means of the rearward-facing environment detection sensor 3. This corresponds to the look over the shoulder of the human vehicle driver.

In order to take into account the topology when planning the lane change and carrying out the lane change, it is provided that the achievable acceleration of the vehicle 2 on the acceleration section BS is determined, wherein the topology of the acceleration section BS is taken into account for this. Furthermore, it is provided that a detection range EB of the rearward-facing environment detection sensor 3 is adapted depending on the topology of the acceleration section BS and/or depending on the topology of the preceding section of the neighboring lane FS.

The detection range EB is adapted in particular when travelling on an acceleration section BS formed as a descending section or ascending section compared to a level acceleration section BS, since then the achievable acceleration of the vehicle 2 changes compared to a level acceleration section BS.

On the level acceleration section BS, the achievable acceleration of the vehicle 2 is achieved merely by a drive arrangement of the vehicle 2, i.e., by one or more drive units, in particular by a motor or more motors, for driving the vehicle 2. The achievable acceleration is then in particular dependent on drive power and loading of the vehicle 2. The achievable acceleration on a level acceleration section BS is therefore referred to as proper acceleration aₑ in the following.

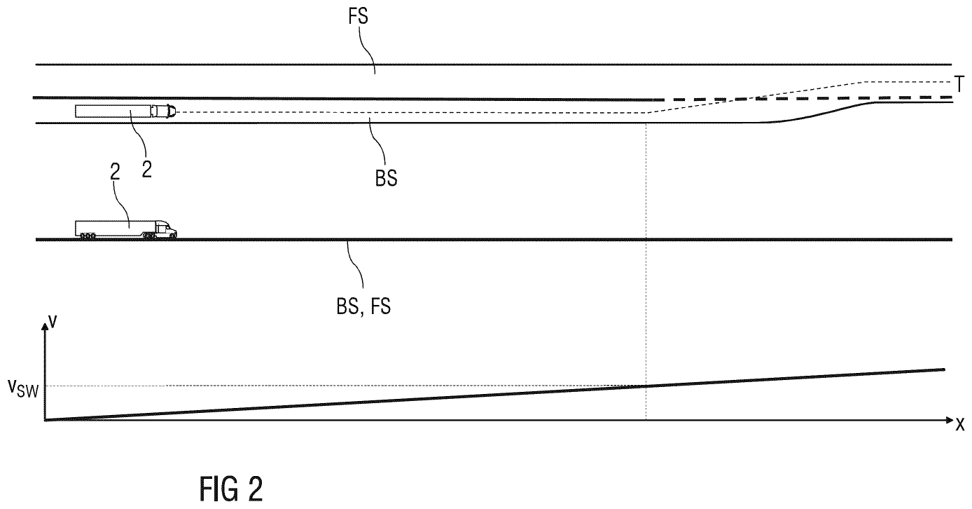

FIG. 2 shows an example of a lane change with a level acceleration section BS. Shown at the top of this figure is a plan view from above of the acceleration section BS and the neighboring lane FS. The planned lane change is represented using a represented planned trajectory T of the vehicle 2. In the centre, a side view of this situation is represented, in which the present level acceleration section BS is visible. A curve of the speed v of the vehicle 2 in relation to a traversed distance x is shown in a diagram at the bottom of the figure. Here a lane change speed v_{SW} is marked which the vehicle 2 has at the time of the lane change.

On an acceleration section BS formed as a descending section, the achievable acceleration of the vehicle 2 with the same load is greater than on the level acceleration section BS, since here the downhill-slope force accelerates the vehicle 2, whereby the vehicle 2 is additionally accelerated in comparison to the level acceleration section BS. The achievable acceleration is thus the sum from the proper acceleration aₑ and a downhill-slope acceleration, resulting from the downhill-slope force acting on the vehicle 2. In this case, the downhill-slope acceleration is calculated as follows:

$${a}_{h} = g \cdot sin ( α ) \qquad ( 1 )$$

Here, g is the gravitational acceleration of the earth and a is the angle of the acceleration section BS with respect to the horizontal.

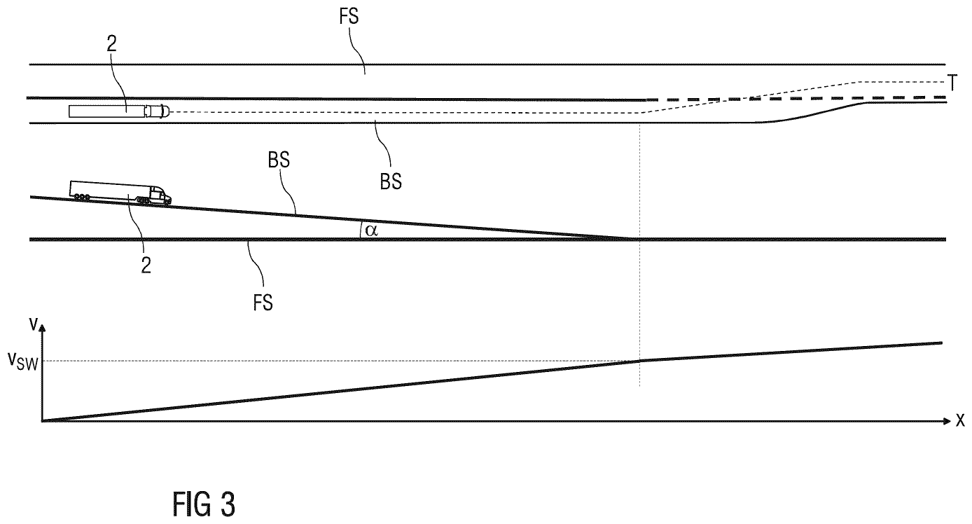

FIG. 3 shows an example of a lane change with an acceleration section BS formed as a descending section. Shown at the top of the figure is a plan view from above of the acceleration section BS and the neighboring lane FS. The planned lane change is represented using the represented planned trajectory T of the vehicle 2. In the centre, a side view of this situation is schematically represented, wherein the curve of the acceleration section BS and the neighboring level, i.e., horizontal, lane FS is represented. Thus, the present acceleration section BS formed in the present case as a descending section and the angle α thereof with respect to the horizontal, here with respect to the level neighboring lane FS, can be seen. The curve of the speed v of the vehicle 2 in relation to the traversed distance x is shown in a diagram at the bottom of the figure. Also marked here is the lane change speed v_{SW} which the vehicle 2 has at the time of the lane change.

In comparison to FIGS. 2 and 3, it is clear that the lane change speed v_{SW} is greater on the acceleration section BS (FIG. 3) formed as a descending section than on the level acceleration section BS (FIG. 2). This results from the downhill-slope acceleration which further accelerates the vehicle 2 in the case of the acceleration section BS formed as a descending section, whereby the vehicle reaches a higher lane change speed v_{SW}.

In the method described here, it is therefore in particular provided that a length x_{EB} of the detection range EB required for the determined lane change speed v_{SW} is determined and the detection range EB is adapted in such a way that the neighboring lane FS is detected over the entire determined required length x_{EB}.

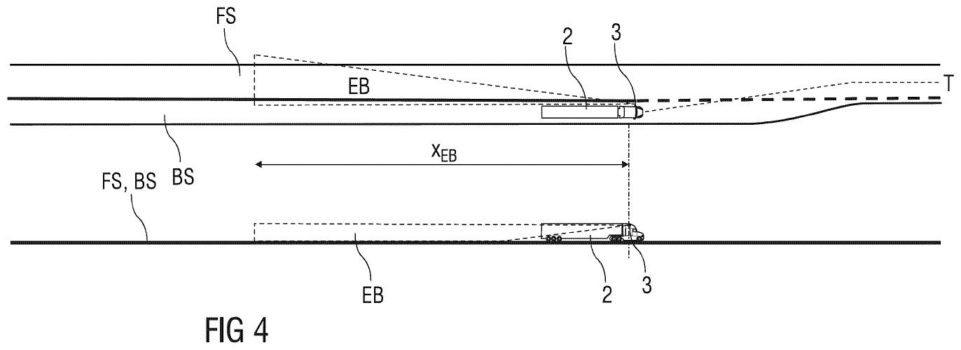

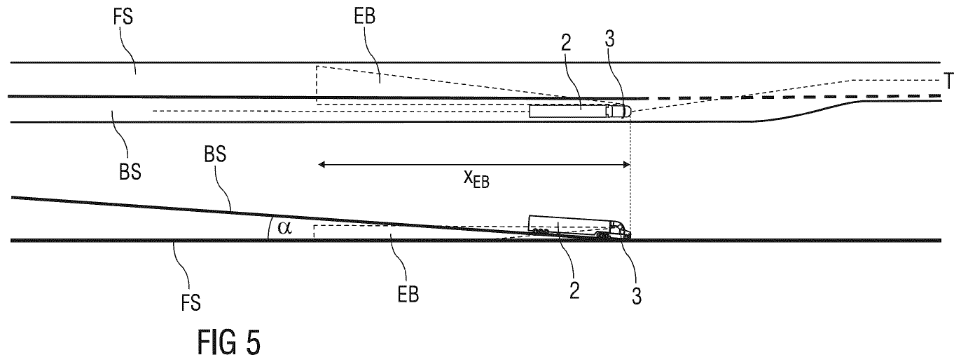

Since the relative speed with respect to road users VT on the neighboring lane FS is lower at greater lane change speeds v_{SW} than at lower lane change speeds v_{SW}, accordingly a shorter length x_{EB} of the detection range EB is required at the higher lane change speed v_{SW} based on the acceleration section BS formed as a descending section according to FIG. 3, than at the lower lane change speed v_{SW} based on the level acceleration section BS according to FIG. 2, as shown in the comparison of FIGS. 4 and 5. Here, FIG. 4 shows the example of the level acceleration section BS and FIG. 5 shows the example of the acceleration section BS formed as a descending section, wherein in each case the plan view from above is shown at the top and the side view is shown at the bottom. In each case, the time of the lane change, i.e., the time at which this is initiated, is shown, as can be seen on the represented planned trajectory T. Additionally shown in each case are the detection range EB of the rearward-facing environment detection sensor 3 and the length x_{EB} thereof.

On an acceleration section BS formed as an ascending section, the achievable acceleration of the vehicle 2 with the same load is lower than on the level acceleration section BS, since here the downhill-slope force decelerates the vehicle 2, whereby the vehicle 2 is accelerated less in comparison to the level acceleration section BS. The achievable acceleration is thus the difference between the proper acceleration aₑ of the vehicle 2 and a down-hill slope deceleration resulting from the downhill-slope force acting on the vehicle 2, wherein here a positive value is used, or the sum of the proper acceleration aₑ and a negative downhill-slope acceleration resulting from the down-hill slope force acting on the vehicle 2, because the deceleration is a negative acceleration.

The lane change speed v_{SW} on the acceleration section BS formed as an ascending section is thus lower than on the level acceleration section BS. This results from the downhill-slope acceleration which counteracts the proper acceleration aₑ of the vehicle 2 in the case of the acceleration section BS formed as an ascending section, whereby the vehicle reaches a lower lane change speed v_{SW}.

Accordingly, a greater length x_{EB} of the detection range EB is required with the lower lane change speed v_{SW} due to the acceleration section BS formed as an ascending section, than with the greater lane change speed v_{SW} due to the level acceleration section BS.

The basic idea of the solution described here is therefore in particular to adapt the detection range EB, in the case of an acceleration section BS formed as a descending section, in accordance with the downhill-slope acceleration acting on the vehicle 2 in an accelerating manner due to the downhill-slope force in addition to its proper acceleration aₑ (and the resulting achievable higher lane change speed v_{SW}), in particular to reduce its length x_{EB}, and, in the case of an acceleration section BS formed as an ascending section, to adapt it in accordance with the downhill-slope deceleration acting on the vehicle 2 due to the downhill-slope force and reducing the proper acceleration aₑ (and the resulting achievable lower lane change speed v_{SW}), in particular to increase its length x_{EB}.

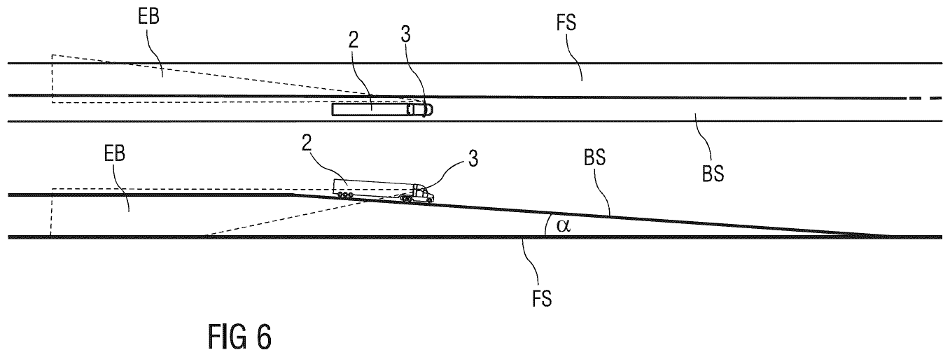

FIG. 6 shows another example in which the vehicle 2 is located in an initial region of the acceleration section BS formed as a descending section. Here as well, the acceleration section BS and the neighboring lane FS is represented at the top in FIG. 6 in a plan view from above and at the bottom in FIG. 6 in a schematic side view. The vehicle 2 approaches a lower level of the neighboring lane FS from a higher level on the acceleration section BS formed as a descending section.

In this case, it is problematic that the detection range EB of the rearward-facing environment detection sensor 3 would be orientated upwards without adaptation due to the inclination of the vehicle 2 on the acceleration section BS, formed as a descending section, and the lower-lying neighboring lane FS, and thus the lower-lying neighboring lane FS would not be detected. Therefore, it is provided that the detection range EB of the rearward-facing environment detection sensor 3 is adapted depending on the topology of the acceleration section BS and depending on the topology of the preceding section of the neighboring lane FS.

In the represented example, in which the acceleration section BS is formed as a descending section which leads onto the lower-lying level of the neighboring lane FS, the detection range EB is thus adapted in such a way that a vertical expansion of the detection range EB, also referred to as a vertical frustum, reaches sufficiently far down in order to detect the lower-lying neighboring lane FS. The detection range EB is thus adapted in particular in such a way that the neighboring lane FS is detected over the entire determined required length x_{EB}.

The adaptation of the detection range EB can, for example, take place by orientating the rearward-facing environment detection sensor 3, e.g., by means of a gimbal actuator. Alternatively, the detection range EB, i.e., the frustum, of the rearward-facing environment detection sensor 3 can be designed corresponding to a maximum uphill lane slope to be expected and/or corresponding to a maximum downhill lane slope to be expected. In the case of an environment detection sensor 3 formed as a camera, this is achievable with a correspondingly large lens aperture angle. The used rearward-facing environment detection sensor 3 is then formed and set up accordingly.

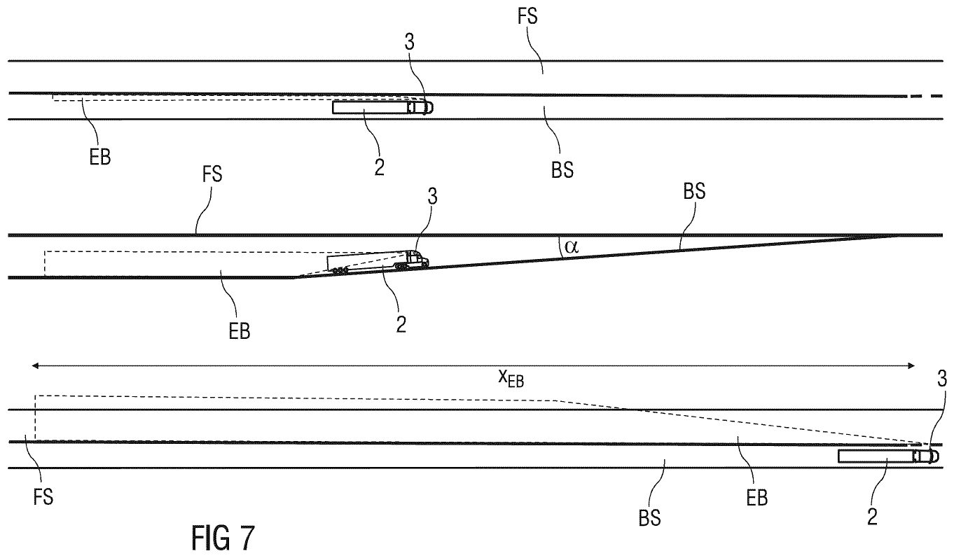

FIG. 7 shows another example in which the vehicle 2 is located in an initial region of the acceleration section BS formed as an ascending section. Here as well, the acceleration section BS and the neighboring lane FS are shown at the top in FIG. 7 in a plan view from above and at the bottom in FIG. 7 in a schematic side view. The vehicle 2 approaches a higher level of the neighboring lane FS from a lower level on the acceleration section BS formed as an ascending section.

In this case, because of the higher level of the neighboring lane FS, it is problematic that the detection range EB, in particular the vertical expansion thereof, i.e., the vertical frustum, is blocked for a very long time by the higher-lying neighboring lane FS. Due to the low lane change speed v_{SW}, which results from the low acceleration of the vehicle 2 due to the acceleration section BS formed as an ascent, and due to the very late detection of the neighboring lane FS by means of the detection range EB of the rearward-facing environment detection sensor 3, for example only shortly before the time of the lane change, a very large length x_{EB} of the detection range EB is required here, as shown in FIG. 7 at the bottom. In this case, the length x_{EB} of the detection range EB is in particular greater than a length x_{EB}, required for the determined lane change speed v_{SW}, without this problem. Thus, here as well, the detection range EB, in particular the length x_{EB} thereof, is adapted depending on the topology of the acceleration section BS and depending on the topology of the preceding section of the neighboring lane FS.

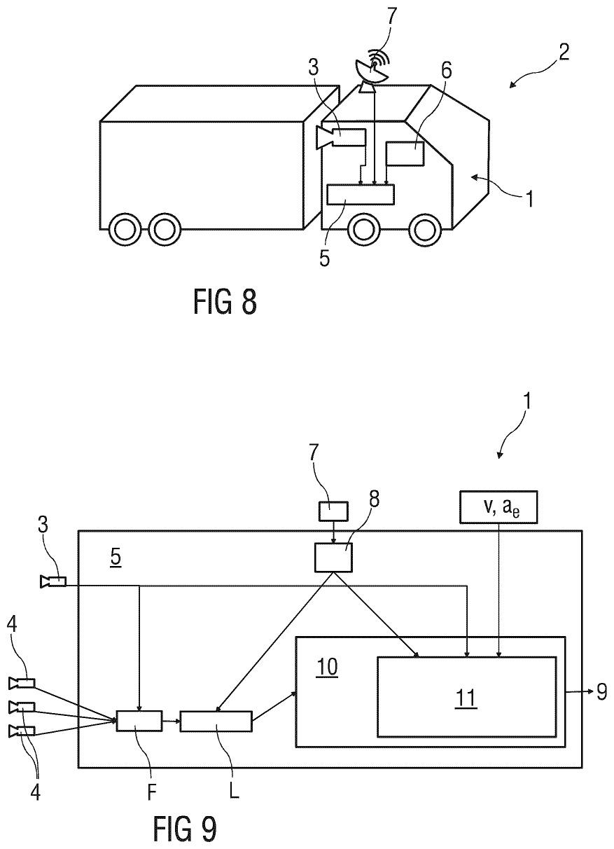

FIG. 8 shows the vehicle 2 with the apparatus 1 for carrying out the method. FIG. 9 shows the apparatus 1 for carrying out the method. The apparatus 1 comprises in particular a determining unit 5 which is formed, for example, as a control device.

The vehicle 2, and in particular also the apparatus 1 thereof, comprises the rearward-facing environment detection sensor 3, the determining unit 5, an inertial sensor system 6 and a position determining unit 7 for determining a current position of the vehicle 2 by means of a global navigation satellite system. The vehicle 2 also comprises further environment detection sensors 4, a digital map 8 and actuators 9. The actuators 9 are in particular provided for longitudinal and lateral control of the vehicle 2. If a gimbal actuator is provided, this can also be one of the actuators 9. Each of these components can also be a component part of the apparatus 1.

In the determining unit 5, formed as a control device, fusion F of data from the environment detection sensors 3, 4 and localization L of the vehicle 2 takes place, in particular by means of fused data from the environment detection sensors 3, 4 and data from the position determining unit 7 and the digital map 8. Data of the localization L is processed in a behavior planning module 10 of the determining unit 5 in order to control the actuators 9 accordingly.

The behavior planning module 10 comprises a lane change planning module 11 in which in particular the length x_{EB} of the detection range EB is determined. This length x_{EB} is dependent on the current speed v of the vehicle 2, on the angle α of the acceleration section BS with respect to the horizontal, and one or more other parameters, i.e., the length x_{EB} is a conversion function of these variables. Therefore, the current speed v of the vehicle 2, the proper acceleration aₑ of the vehicle 2 and the angle α of the acceleration section BS with respect to the horizontal is entered into the lane change planning module 11.

The current speed v of the vehicle 2 is, for example, determined by means of a speed detection sensor system of the vehicle 2 and/or the apparatus 1. The proper acceleration aₑ is, for example, specified, also depending on the load of the vehicle 2, in particular the weight thereof. The weight of the load and thus a total weight of the vehicle 2, which influences the proper acceleration aₑ, can for example be specified or can be determined by means of a corresponding weight detection sensor system of the vehicle 2 and/or the apparatus 1. The lane change planning module 11 receives the angle α of the acceleration section BS in particular from the digital map 8, in particular depending on a current position of the vehicle 2 determined by means of the position determining unit 7. Alternatively or additionally, the angle α of the acceleration section BS can also be determined, for example, by means of the inertial sensor system 6 when the vehicle 2 travels on the acceleration section BS.

The required length x_{EB} of the detection range EB can be calculated at any time for any planning of the lane change process. The conversion function for determining the length x_{EB} of the detection range EB, as already explained above, along with the current speed v of the vehicle 2 and the angle α of the acceleration section BS with respect to the horizontal, is also dependent on one or more other parameters, in particular on many other parameters, for example on expected relative speeds with respect to other road users VT, i.e., on an over-speed factor, also referred to as over-speeding factor.

List of reference characters:

| | |
|---|---|
| 1 | apparatus |
| 2 | vehicle |
| 3 | rearward-facing environment detection sensor |
| 4 | further environment detection sensor |
| 5 | determining unit |
| 6 | inertial sensor system |
| 7 | position determining unit |
| 8 | map |
| 9 | actuator |
| 10 | behavoir planning module |
| 11 | lane change planning module |
| aₑ | proper acceleration |
| BS | acceleration section |
| EB | detection range |
| F | fusion |
| FS | lane |
| L | localization |
| T | trajectory |
| v | speed |
| v_{SW} | lane change speed |
| VT | other road users |
| x | distance |
| x_{EB} | length of the detection range |
| α | angle of acceleration section with respect to the horizontal |

1.-10. (canceled)

11. A method for planning a lane change of a vehicle (2) from an acceleration section (BS), on which the vehicle (2) is accelerated, to a neighboring lane (FS), wherein a topology of the acceleration section (BS) is taken into account to determine an achievable acceleration of the vehicle (2) over the acceleration section (BS), comprising the step of:
adapting a detection range (EB) of at least one rearward-facing environment detection sensor (3) of the vehicle (2) depending on the topology of the acceleration section (BS) and/or of a preceding section of the neighboring lane (FS).

12. The method according to claim 11, wherein a lane change speed (v_{SW}) is determined and wherein the detection range (EB) is adapted depending on the determined lane change speed (v_{SW}).

13. The method according to claim 12, wherein a length (x_{EB}) of the detection range (EB) required for the determined lane change speed (v_{SW}) is determined and wherein the detection range (EB) is adapted such that the neighboring lane (FS) is detected over an entirety of the determined length (x_{EB}).

14. The method according to claim 11, wherein the at least one rearward-facing environment detection sensor (3) is a camera.

15. The method according to claim 11, wherein the detection range (EB) is adapted by orientating the at least one rearward-facing environment detection sensor (3).

16. The method according to claim 15, wherein the at least one rearward-facing environment detection sensor (3) is orientated by a gimbal actuator.

17. The method according to claim 11, wherein the detection range (EB) is adapted by adapting a focal length or an angle of view or a lens aperture angle of the at least one rearward-facing environment detection sensor (3).

18. An apparatus (1) for planning a lane change of a vehicle (2), wherein the apparatus (1) is configured to perform the method according to claim 11.

19. The apparatus (1) according to claim 18, comprising a determining unit (5) for determining an achievable acceleration of the vehicle (2) over the acceleration section (BS) and the detection range (EB).

20. The apparatus (1) according to claim 18, comprising at least one rearward-facing environment detection sensor (3), a position determining unit (7) for determining a current position of the vehicle (2), a digital map (8), an inertial sensor system (6), and a speed detection sensor system for detecting a current speed (v) of the vehicle (2).
